(19) United States
(12) Patent Application Publication
(10) Pub. No.: US 2025/0127669 A1
(43) Pub. Date: Apr. 24, 2025

(54) LIFT FOR CHANGING THE POSITION OF THE SEAT IN A WHEELCHAIR

(71) Applicant: REAC AB, Göteborg (SE)

(72) Inventor: Zbigniew Sielski, Belchatow (PL)

(21) Appl. No.: 18/917,652

(22) Filed: Oct. 16, 2024

(30) Foreign Application Priority Data
Oct. 20, 2023 (PL) P.446444

(51) Int. Cl. A61G 5/10

(52) U.S. Cl. CPC A61G 5/1059

(57) ABSTRACT

A lift for changing position of a seat in a wheelchair features an upper frame consisting of a horizontal fixed part and a tilting plate, where the tilting plate is pivotally and slidably mounted with pins in fixed part guides, where the second support for the tilting plate is provided by tilting arms, which are pivotally connected to the tilting plate by means of pins, with the tilting arms mounted at their lower end on a pin in the upper frame and driven by an actuator, where the base of the lift consists of a lower frame, in which the scissor lifting mechanism arms of the upper frame are pivotally mounted and driven by an actuator, where fixed part guides consist of aluminium profiles with three horizontal plates connected by two vertical plates, and each two adjacent horizontal plates are connected by a vertical plate.

### CROSS REFERENCE TO RELATED APPLICATIONS

The present patent application is a U.S. national application filed under 35 U.S.C. 111 (a), which claims priority to Polish Application P. 446444, filed on Oct. 20, 2023, the content of which is incorporated in this patent application by reference in its entirety for all purposes.

### FIELD

The subject of the invention is the lift for changing position of the seat in a wheelchair intended for use in wheelchairs for people with significant disabilities. The lift is particularly useful in wheelchairs intended for children.

### BACKGROUND

A lift from the description P.397089 is known, in which the upper frame consists of a horizontal fixed part and a tilting plate. The tilting plate is pivotally and slidably mounted with pins in fixed part guides. The second support for the tilting plate consists of tilting arms, which are connected to the tilting plate rotatably by means of pins. The tilting arms are mounted at their lower end on a pin in the upper frame. The base of the lift consists of a lower frame, in which the arms of the scissor lifting mechanism for the upper frame are pivotally mounted. The actuators are mounted parallel to each other so that the actuator bodies are on one side and the extendable elements are on the other.

The technical issue lies in the fact that the lift is characterized by a significant mass. This affects the overall weight of the wheelchair significantly. Along with the weight of the wheelchair, difficulties arise in its movement, energy consumption increases, and there's a higher risk of more severe injuries in case of collisions, etc. The technical issue is also considerable dimensions of the lift.

### SUMMARY

The aim of the invention is to develop a lift with reduced mass characterized by the smallest possible dimensions, especially a smaller lift width.

The essence of the solution is a lift for changing position of the seat in a wheelchair, in which the upper frame consists of a horizontal fixed part and a tilting plate and the tilting plate is pivotally and slidably mounted with pins in the fixed part guides, whereas the second support of the tilting plate are tilting arms, which are connected to the tilting plate pivotally by means of pins, wherein the tilting arms are mounted at their lower end on a pin in the upper frame and driven by an actuator and the base of the lift is a lower frame, in which the arms of the scissor lifting mechanism of the upper frame are pivotally mounted and driven by an actuator in which the fixed part guides consist of aluminium profiles with three horizontal plates connected by two vertical plates. Each two adjacent horizontal plates are connected by a vertical plate, wherein the vertical plates are placed on opposite edges of the horizontal plates. The horizontal plates are equipped with projections protecting the fixed part guides. In the upper external space between the horizontal plates there are pins and in the lower internal space between the horizontal plates there are pins of arm of the scissor lifting mechanism of the upper frame. The profiles of the lower frame have two horizontal plates connected by two vertical plates. The profiles of the lower frame between the vertical plates have mounting sockets, to which the lower frame cross members are attached. The actuator bodies are located on opposite sides of the upper frame and the lower frame. The motor connected to the actuator and the motor connected to the actuator are placed in the space between the actuators. The actuator is attached to the cross member of the tilting arms, and the actuator is attached to the lever connected to the arm of the scissor lifting mechanism of the upper frame.

The solution according to the invention allows to reduce the mass of the lift, providing sufficient load-bearing capacity for children's wheelchairs. The alternating arrangement of the actuators allows to reduce the width of the lift. Additionally, the use of profiles allows for more precise construction of the lift, which reduces the resistance to the movement of the lift. Replacing welded structures with profiles also reduces the time required for the assembly of the lift.

### BRIEF DESCRIPTION OF THE DRAWING

The subject of the invention is illustrated in the drawing, where

FIG. 1 shows an isometric projection of the lift,

FIG. 2—a cross-section of the profile of the upper frame,

FIG. 3—a cross-section of the profile of the lower frame,

FIG. 4—bottom view of the lift,

FIG. 5—rear view of the lift, and

FIG. 6—side view of the lift.

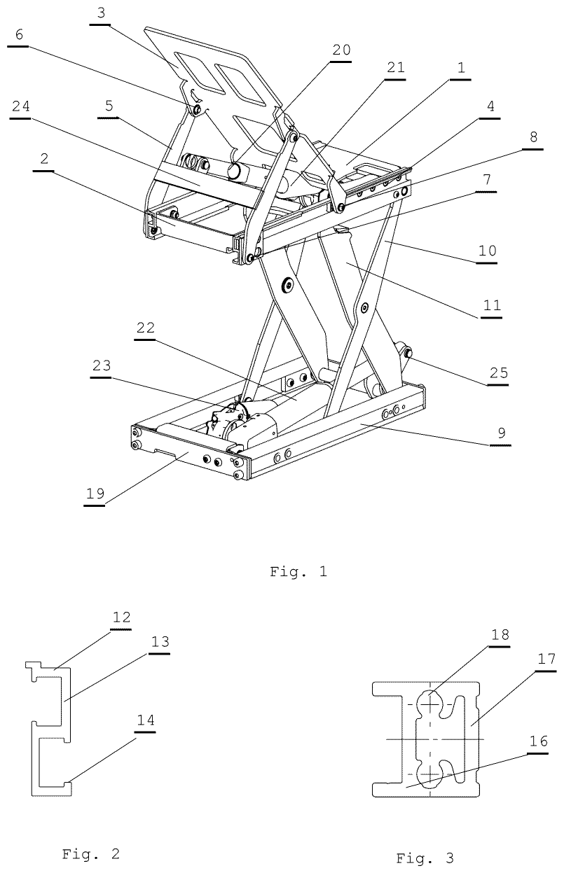

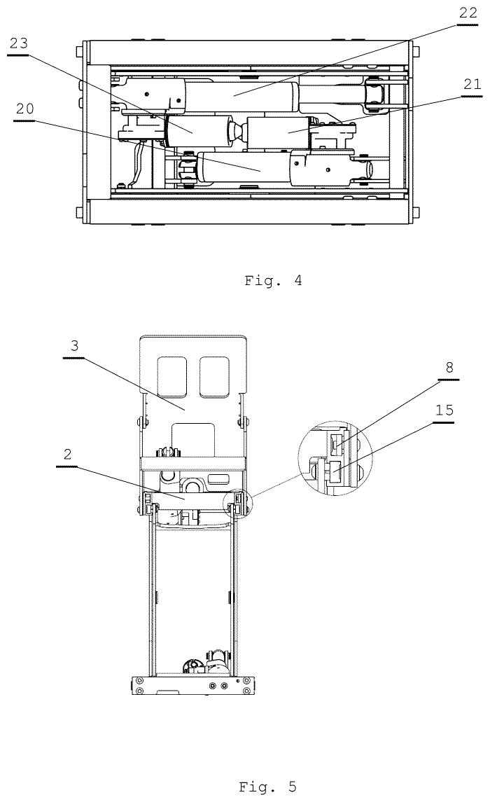

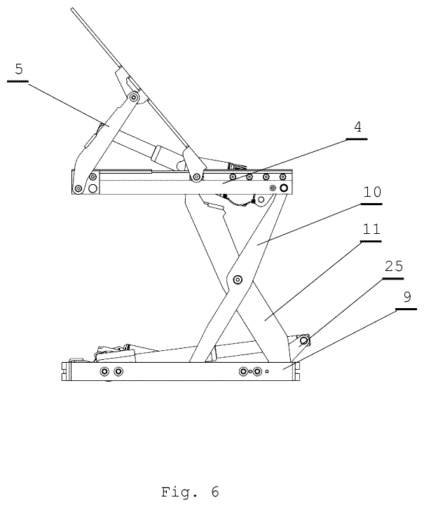

### DETAILED DESCRIPTION OF THE PREFERRED EMBODIMENTS

Example. Lift for changing position of the seat in a wheelchair features an upper frame 1 consisting of a horizontal fixed part 2 and a tilting plate 3. The tilting plate 3 is pivotally and slidably mounted with pins 8 in fixed part guides 4. The second support for the tilting plate 3 is provided by tilting arms 5, which are pivotally connected to the tilting plate 3 by means of pins 6, with the tilting arms 5 mounted at their lower end on a pin 7 in the upper frame 1. The base of the lift consists of a lower frame 9, in which the scissor lifting mechanism arms 10 and 11 of the upper frame are pivotally mounted. The fixed part 2 along with the fixed part guides 4 and the lower frame 9 are made of aluminium profiles. The fixed part guides 4 consist of aluminium profiles with three horizontal plates 12 connected by two vertical plates 13. Each two adjacent horizontal plates 12 are connected by a vertical plate 13, wherein the vertical plates 13 are placed on opposite edges of the horizontal plates 12. The shape of the vertical plates 13 and horizontal plates 12 causes the profile to have a cross-section similar to the letter “S”. The horizontal plates are equipped with projections 14 protecting the fixed part guides 4. In the upper external space between the horizontal plates 12 there are pins 8 and in the lower internal space between the horizontal plates 12 there are pins 15 of arm 11 of the scissor lifting mechanism of the upper frame. The profiles of the lower frame 9 have two horizontal plates 16 connected by two vertical plates 17. The profiles of the lower frame 9 between the vertical plates 17 have mounting sockets 18, to which the lower frame cross members 19 are attached. The movement of the tilting plate is achieved by means of the actuator 20 driven by the motor 21 arranged parallel to the actuator 20, and the lifting of the upper frame 1 is achieved by means of the actuator 22 driven by the motor 23 arranged parallel to the actuator 22. The actuator bodies 20 and 22 are located on opposite sides of the upper frame 1 and the lower frame 9. The motor 21 connected to the actuator 20 and the motor 23 connected to the actuator 22 are placed in the space between the actuators 20 and 22. The attachment of the actuators 20 and 22 on opposite sides causes the motors 21 and 23 to be attached on opposite sides as well. The axes of the motors 21 and 23 are slightly offset from each other. The actuator 20 is attached to the cross member 24 of the tilting arms 5, and the actuator 22 is attached to the lever 25 connected to the arm 11 of the scissor lifting mechanism of the upper frame.

1. A lift for changing position of the seat in a wheelchair, in which an upper frame comprises a horizontal fixed part and a tilting plate and the tilting plate is pivotally and slidably mounted with pins in fixed part guides, whereas a second support of the tilting plate are tilting arms, which are connected to the tilting plate pivotally by means of pins, wherein the tilting arms are mounted at their lower end on a pin in the upper frame and driven by an actuator, and a base of the lift is a lower frame, in which arms of a scissor lifting mechanism of the upper frame are pivotally mounted, and driven by an actuator characterized in that the fixed part guides (4) comprises aluminium profiles with three horizontal plates (12) connected by two vertical plates (13).

2. The lift according to claim 1, characterized in that each of two adjacent horizontal plates (12) are connected by a vertical plate (13), wherein the vertical plates (13) are placed on opposite edges of the horizontal plates (12).

3. The lift according to claim 2, characterized in that the horizontal plates are equipped with projections (14) protecting the fixed part guides (4).

4. The lift according to claim 2, characterized in that in an upper external space between the horizontal plates (12) there are pins (8) and in a lower internal space between the horizontal plates (12) there are pins (15) of arm (11) of the scissor lifting mechanism of the upper frame.

5. The lift according to claim 1, characterized in that the profiles of the lower frame (9) have two horizontal plates (16) connected by two vertical plates (17).

6. The lift according to claim 5, characterized in that the profiles of the lower frame (9) between the vertical plates (17) have mounting sockets (18), to which lower frame cross members (19) are attached.

7. The lift according to claim 1, characterized in that actuator bodies (20 and 22) are located on opposite sides of the upper frame (1) and the lower frame (9).

8. The lift according to claim 7, characterized in that a motor (21) connected to the actuator (20) and a motor (23) connected to the actuator (22) are placed in the space between the actuators (20 and 22).

9. The lift according to claim 1, characterized in that the actuator (20) is attached to a cross member (24) of the tilting arms (5), and the actuator (22) is attached to the lever (25) connected to the arm (11) of the scissor lifting mechanism of the upper frame.
